(19) United States
(12) Patent Application Publication
(10) Pub. No.: US 2007/0271969 A9
(43) Pub. Date: Nov. 29, 2007

(54) Padlock

(76) Inventors: Chun Te Yu, Fusing Township (TW); Cory o. Nukoluk, St.Louis, MO (US)

Correspondence Address: CHARLES C.H. WU, 98 DISCOVERY, IRVINE, CA, 92618-3105, US

(21) Appl. No.: 10/671,659

(22) Filed: Sep. 29, 2003

Related U.S. Application Data
(60) Provisional application No. 60/443,331, filed on Jan. 29, 2003.

(30) Foreign Application Priority Data
Aug. 22, 2003 (TW) 92115338

(51) Int. Cl. E05B 37/02; E05B 37/00

(52) U.S. Cl. 70/25; 70/38 C; 70/284

(57) ABSTRACT

A padlock that can be unlocked by the owner of the padlock by dialing an unlocking number or by authorized security personals with a general key. The padlock mainly contains a lock body, a block, a shackle, a general locking means and a private locking means. The lock body has a first channel and a second channel therein. The block is engaged with the second channel. The block has a receptacle therein. The shackle has a longer arm slidably received in the first channel and a shorter arm engagable with the receptacle of the block. The general locking means is formed in the lock body for locking or unlocking the longer arm of the shackle. The private locking means is formed in the lock body for controlling movements of the block in order the block to be engaged with or disengaged from the shorter arm of the shackle.

### TECHNICAL FIELD

This invention relates generally to a padlock, in particular, to provide a padlock having a shackle locked by a key operated locking means at one end and a combination locking means at another end, thereby the padlock can be unlocked by using a key or by dialing the combination locking means to an unlocking number.

### BACKGROUND OF THE INVENTION

Preventing personal stuffs from being lost or stolen, travelers usually lock their own travel baggage boxes. Combination lock is the most common lock that installed in a travel baggage box because it takes little space. Each traveler sets up his own security number for the combination lock. Thereby others without knowing the security number cannot unlock his baggage box. However terrorists may use travel baggage boxes to deliver explosive devices to endanger people's safety. Security personals in airports may need to exam travels' travel baggage boxes in some circumstances without presence of the owners of the travel baggage boxes. Some countries require travelers not to lock their travel baggage boxes. The travelers may lose their properties in their travel baggage boxes if they leave their travel baggage boxes unlocked. If they choose to lock their baggage boxes, the security personals are authorized to damage the travel baggage boxes in order to exam objects inside of the travel baggage boxes. There is a dilemma between travelers' rights and flight safety. Therefore, a padlock that can protect travels' properties and allow security personals to unlock the padlock is needed as well.

### SUMMARY OF INVENTION

It is therefore an objective of the present invention to provide a padlock that can be unlocked by the owner of the padlock by dialing an unlocking number or by authorized security personals with a general key.

The present invention, briefly summarized, in one embodiment discloses a padlock. The padlock mainly contains a lock body, a block, a shackle, a general locking means and a private locking means. The lock body has a first channel and a second channel therein. The block is engaged with the second channel. The block has a receptacle therein. The shackle has a longer arm slidably received in the first channel and a shorter arm engagable with the receptacle of the block. The general locking means is formed in the lock body for locking or unlocking the longer arm of the shackle. The private locking means is formed in the lock body for controlling movements of the block in order the block to be engaged with or disengaged from the shorter arm of the shackle.

### BRIEF DESCRIPTION OF DRAWINGS

The invention will be more clearly understood after referring to the following detailed description read in conjunction with the drawings wherein:

FIG. 1 is a perspective view of the first embodiment of present invention;

FIG. 2 is a cross sectional view of the locked first embodiment;

FIG. 3 is a perspective view of the key operated locking means of the first embodiment;

FIG. 4 is a cross sectional view of the first embodiment demonstrating the key operated locking means engaged with the flange of the longer arm of the shackle;

FIG. 5 is a perspective view of the first embodiment showing the block being moved downwardly and the shorter arm of the shackle being removed from the receptacle of the block;

FIG. 6 is a cross sectional view of the first embodiment showing the longer arm of the shackle being released from the key operated locking means;

FIG. 7 is a cross sectional view of the first embodiment demonstrating the flange of the longer arm of the shackle being released from the key operated locking means;

FIG. 8 is a cross sectional view of the second embodiment showing the shackle being in a locked position;

FIG. 9 is a cross sectional view of the semi-cylinder engaged with the rectangular bump of the locking block of the second embodiment;

FIG. 10 is a cross sectional view of the second embodiment showing the block being moved downwardly and the shorter arm of the shackle being disengaged from the receptacle of the block;

FIG. 11 is a cross sectional view of the first embodiment showing the longer arm of the shackle being released from the hook of the locking block;

FIG. 12 is a cross sectional view of the semi-cylinder rotated and press against the rectangular bump of the locking block of the second embodiment;

FIG. 13 is a perspective view of the third embodiment;

FIG. 14 is a cross sectional view of the third embodiment showing the shackle being locked;

FIG. 15 is a exploded view of the block of the third embodiment;

FIG. 16 is a perspective view of the third embodiment showing the gap of the receptacle of the block being rotated to a position for releasing the shorter arm of the shackle;

FIG. 17 is a cross sectional view of the third embodiment showing the shorter arm of the shackle be released from the gap of the receptacle of the block;

FIG. 18 is a perspective view of the forth embodiment;

FIG. 19 is a cross sectional view of the forth embodiment showing the shackle being locked;

FIG. 20 is an exploded view of the key operated locking means and the block of the forth embodiment;

FIG. 21 is a cross sectional view of the forth embodiment showing the longer arm of the shackle being released from the combination locking means;

FIG. 22 is a perspective view of the forth embodiment showing a slot of the engaging portion of the block being rotated to a position for releasing the shorter arm of the shackle;

FIG. 23 is a cross sectional view of the forth embodiment showing the slot of the engaging portion of the block being rotated by the key and the shorter arm of the shackle be removed from the slot;

FIG. 24 is a perspective view of the fifth embodiment;

FIG. 25 is a cross sectional view of the fifth embodiment showing the shackle being locked and the protrusion of the block being engaged with the hemi-cylinder for preventing the block from rotation;

FIG. 26 is a perspective view of the fifth embodiment showing the block being rotated to allow the shorter arm of the shackle being released from the slot;

FIG. 27 is a cross sectional view of the fifth embodiment showing the key rotates the hemi-cylinder to a position for allowing the block being rotated to allow the shorter arm of the shackle being released from the slot;

FIG. 28 is a perspective view of the sixth embodiment;

FIG. 29 is a cross sectional view of the sixth embodiment showing the shackle being locked;

FIG. 30 is an exploded view of the engaging portion and the mounting portion of the block of the sixth embodiment; and

FIG. 31 is a cross sectional view of the sixth embodiment showing the block being moved downwardly for releasing the shorter arm of the shackle.

### DETAILED DESCRIPTION OF PREFERRED EMBODIMENTS

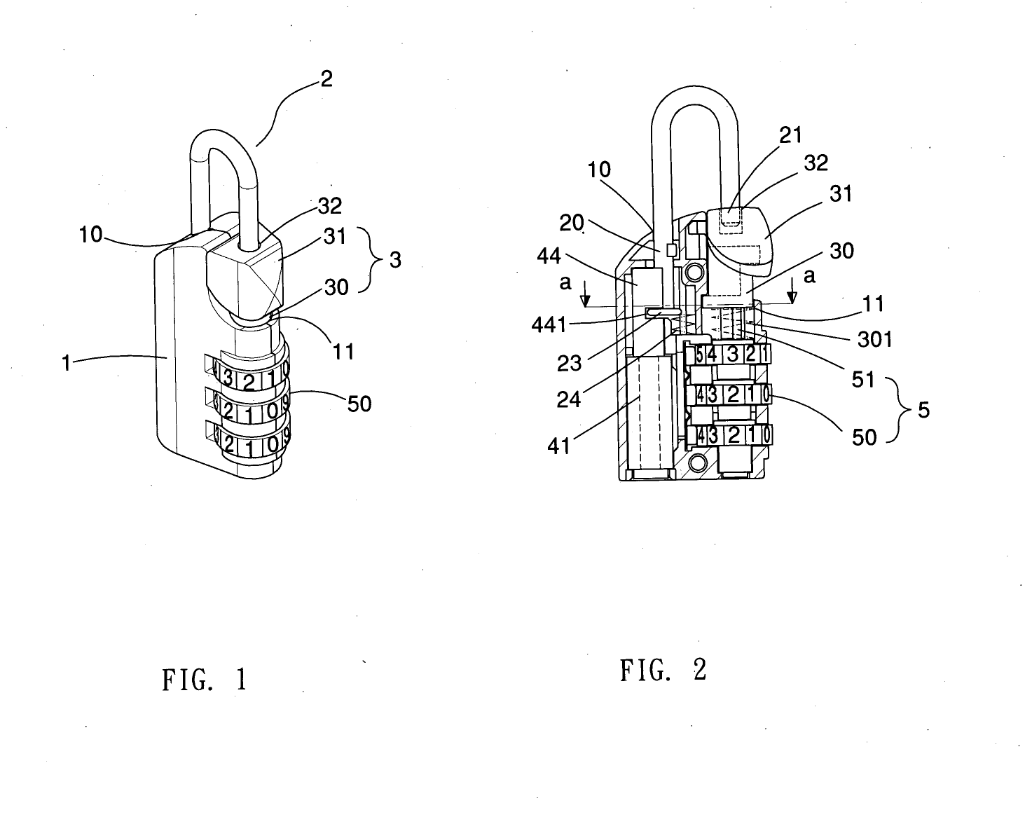

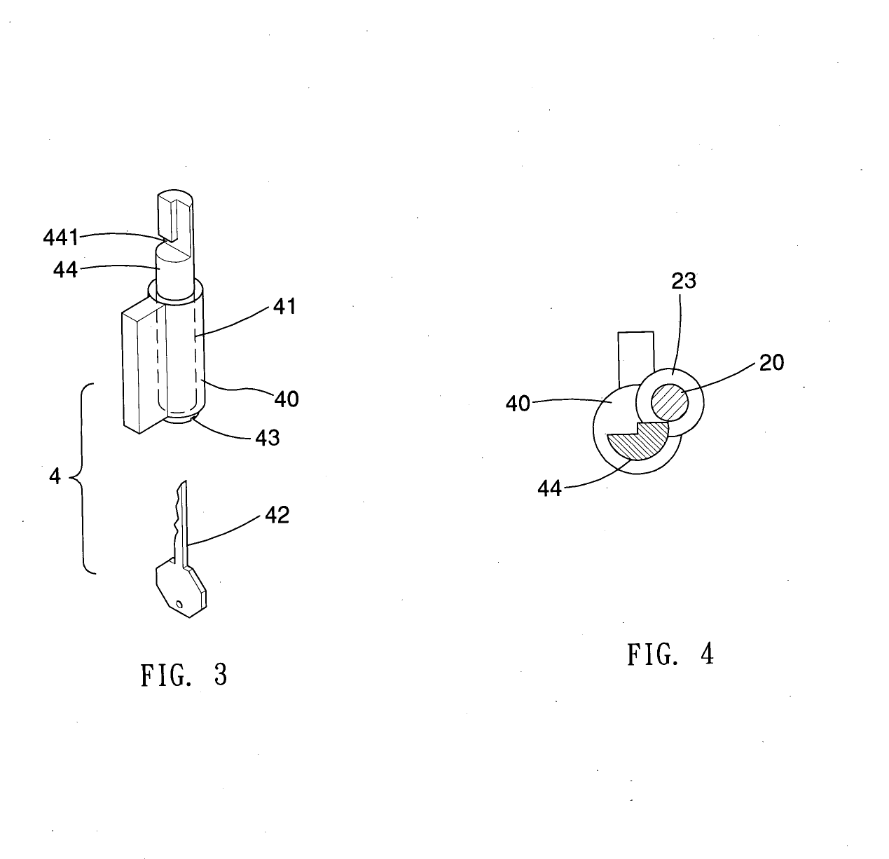

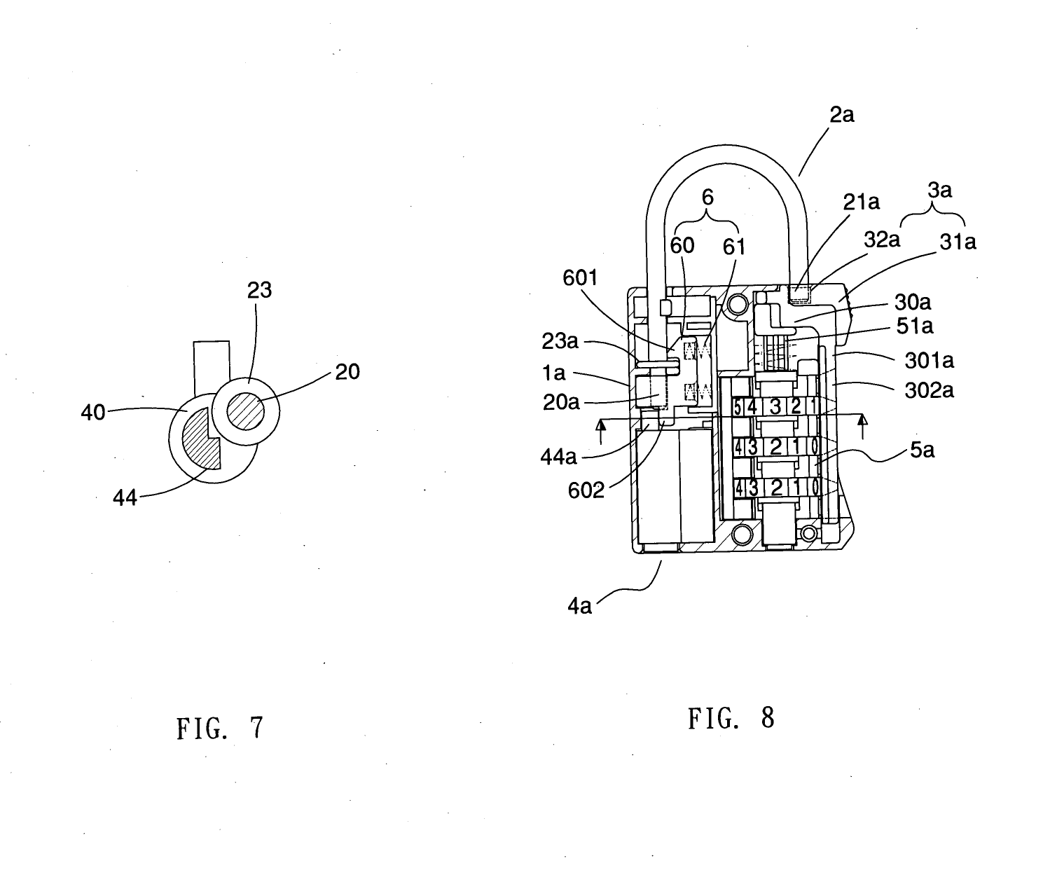

With reference to FIG. 1 and FIG. 2, the padlock of the first embodiment contains a lock body 1, a block 3, a shackle 2, a key operated locking means 4 and a combination locking means 5. The lock body 1 has a first channel 10 and a second channel 11 therein. The block 3 contains an engaging portion 31 having a receptacle 32 therein and a mounting portion 30 under the engaging portion 31. The mounting portion 30 is received in the second channel 11 of the lock body 1. The combination locking means 5 is formed in the lock body 1 for controlling movements of the block 3 in order the block 3 to be engaged with or disengaged from the shorter arm 21 of the shackle 2. The combination locking means 5 contains a stem 51 connected to the mounting portion 30 and plural number wheels 50 rotatably mounted around the stem 51 for controlling vertical movement of the block 3. Only when the number wheel is dialed to the unlocking number the stem 51 can move vertically. The engaging portion 31 is located outside of the second channel 11 of the lock body 1. The shackle 2 has a longer arm 20 slidably received in the first channel 10 and a shorter arm 21 engagable with the receptacle 32 of the block 3. The longer arm 20 of the shackle 2 having a flange 23 near an end thereof. The key operated locking means 4 is formed in the lock body 1 for locking or unlocking the longer arm 20 of the shackle 2. Referring to FIG. 3, FIG. 4 and FIG. 7, the key operated locking means 4 contains: a body 40 having a rotor 41 received therein and a driving rod 44 extended from the rotor 41. The rotor 41 has a keyhole 43 at a bottom end thereof for being engaged with a key 42. The driving rod 44 has the notch 441 therein engagable with the flange 23 of the longer arm 20 of the shackle 2. The key 42 can rotate the rotor 41 and the driving rod 44 to disengage the notch 441 from the flange 23.

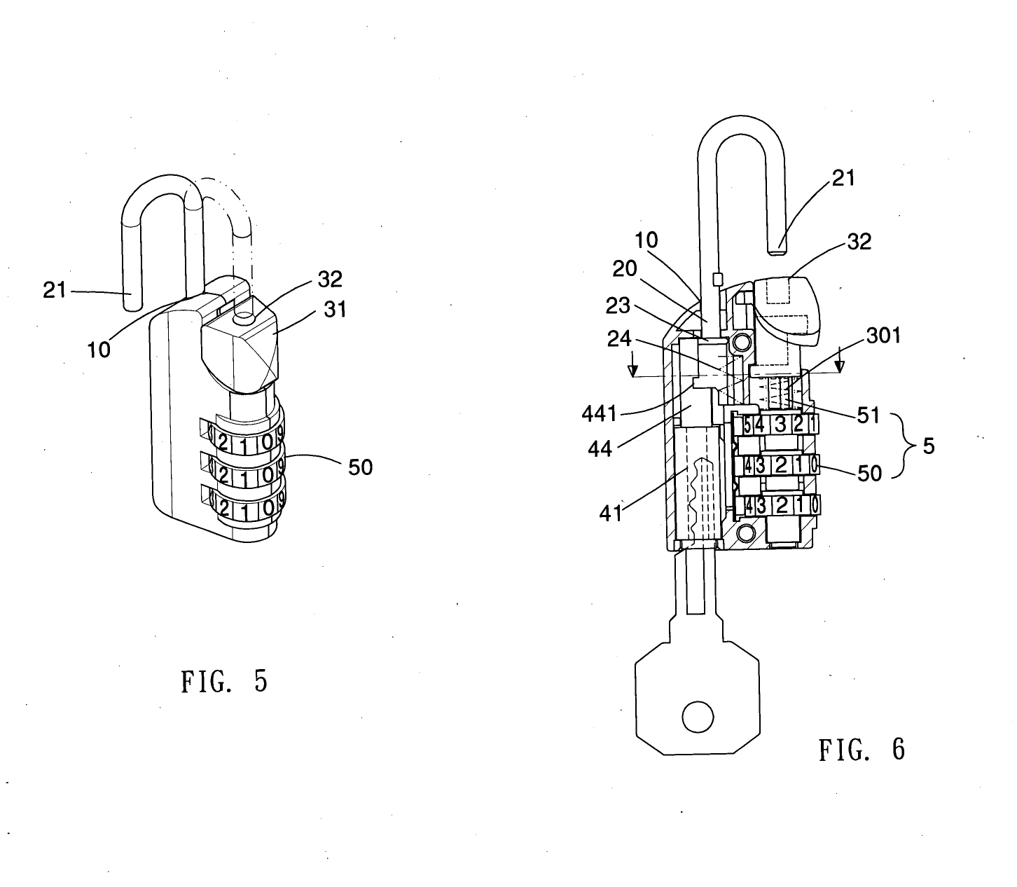

With reference to FIG. 2 and FIG. 5, when the number wheels 50 are dialed to an unlocking number, the stem 51 can move vertically. Since the stem 51 is connected to the mounting portion 30 of the block 3 and the mounting portion 30 connected under the engaging portion 31, the engaging portion 31 of the block 3 can be moved downwardly and the shorter arm 21 of the shackle 2 can be removed from the receptacle 32 of the block 3.

Referring to FIG. 2 and FIG. 6, a first spring 24 is engaged with the flange 23 of the longer arm 20 of the shackle 2 for biasing the shackle 2. Therefore when the notch 441 is not engaged with the flange 23, the spring 24 can automatically eject the longer arm 20 of the shackle 2 out. Because the shorter arm 21 and the longer arm 20 are rigidly connected, when the longer arm 20 is ejected upwardly, the shorter arm 21 is also biased out of the receptacle 23 of the block 3. With reference to FIG. 2 and FIG. 5, the second spring 301 is located between the combination locking means 5 and the block 3. The second spring 301 can restore the block 3 to original position and thereby the receptacle 32 can be engaged with the shorter arm 21 of the shackle 2.

In view of the above descriptions, the shorter arm 21 of the shackle 2 can be removed from the receptacle 23 of the block 3 to an unlocked position by using the key 42 to unlock the key operated locking means 4 or dialing the number wheels 50 to an unlocking number. Padlock manufactures can be requested by the government having security concern to make many padlocks with same key operated locking means 4 and the users can decide their own unlocking number. Thereby, only the owner of the padlock or the authorized security personal with the particular key 42 can open the padlock. Accordingly travelers can prevent properties locked by the padlock from being lost and the security personals can open the padlock when necessary and others cannot open the padlock.

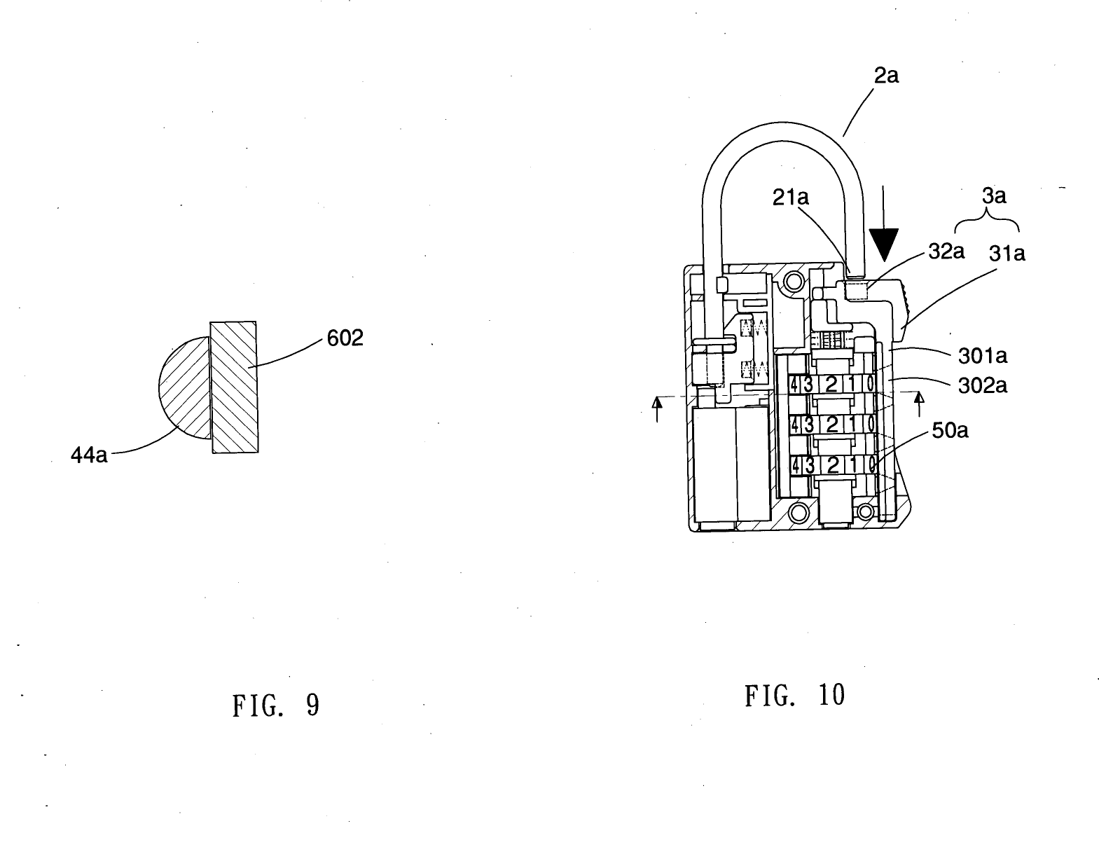

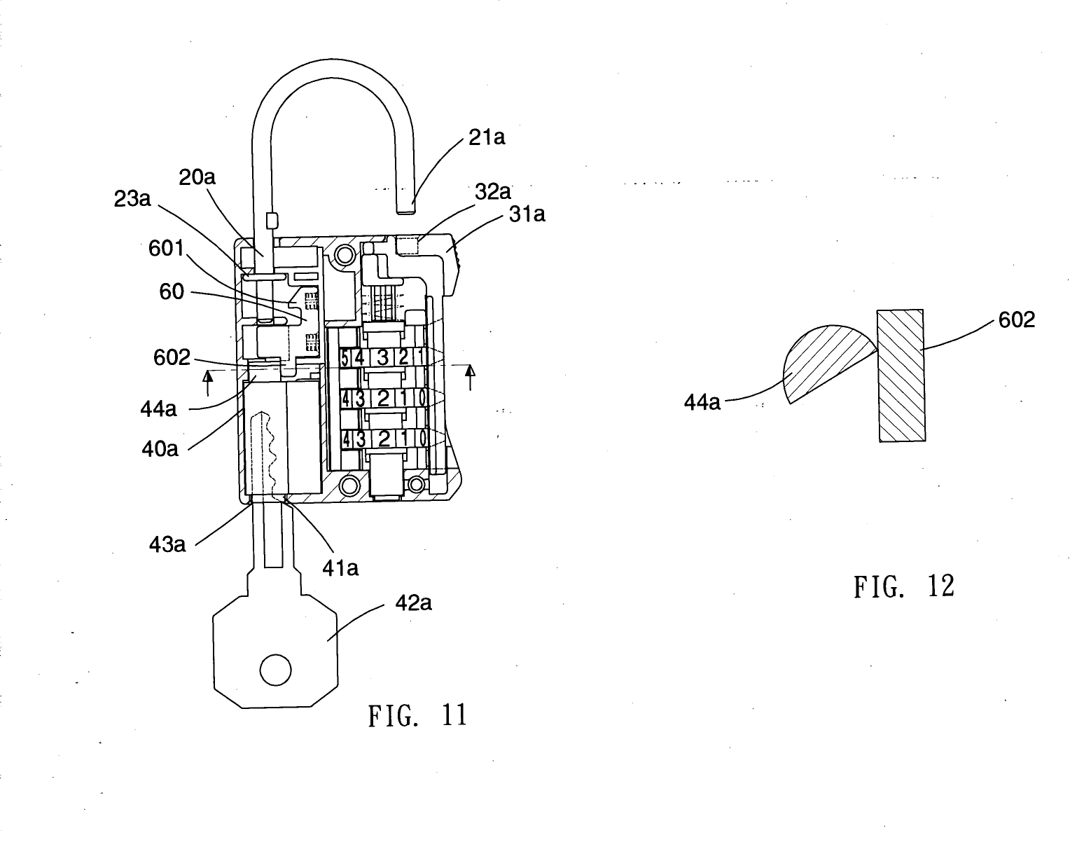

The padlock of the second embodiment of the present invention is illustrated in FIG. 8, FIG. 10 and FIG. 11. The second embodiment contains a lock body 1a, a block 3a, a shackle 2a and a combination locking means 5a the same as the first embodiment. The block 3a further contains a hood 301a mounted thereto. The hood 301a moves synchronously with the block 3a. The hood 301a contains plural windows 302a therethrough, corresponding to the number wheels 50a of the combination locking means 5a. Thereby, when the padlock is locked, the hood 301a covers the number wheels 50a for preventing them from being reached. If the padlock is unlocked, the number wheels 50a can be reached through the windows 302a. The second embodiment further contains a locking mechanism 6 formed therein. The locking mechanism 6 contains: a locking block 60 having a hook 601 thereon engagable with the flange 23a of the longer arm 20a of the shackle 2a, a rectangular bump 602 thereon and a spring 61 for biasing the locking block 60 to engage with the flange 23a of the longer arm 20a of the shackle 2a. With reference to FIG. 8 and FIG. 11, the key operated locking means 4a of the second embodiment contains: a body 40a having a rotor 41a received therein and a hemi-cylinder 44a extended from the rotor 41a. The rotor 41a has a keyhole 43a at a bottom end thereof for being engaged with a key 42a. The hemi-cylinder 44a is engaged with the rectangular bump 602 for releasing the hook 601 of the locking block 60 from the flange 23a of the longer arm 20a of the shackle 2a. Referring to FIG. 9, when the flat surface of the hemi-cylinder 44a is overlaid with the flat surface of the rectangular bump 602, the hook 601 is engaged with the flange 23a of the longer arm 20a. Referring to FIG. 11 and FIG. 12, when the hemi-cylinder 44a is rotated by the key 42a to press against the rectangular bump 602 to move the locking block 60 away from the flange 23a, the hook 601 is disengaged from the flange 23a of the longer arm 20a. The longer arm 20a then be biased upward and the shorter arm 21a is removed from the receptacle 32a.

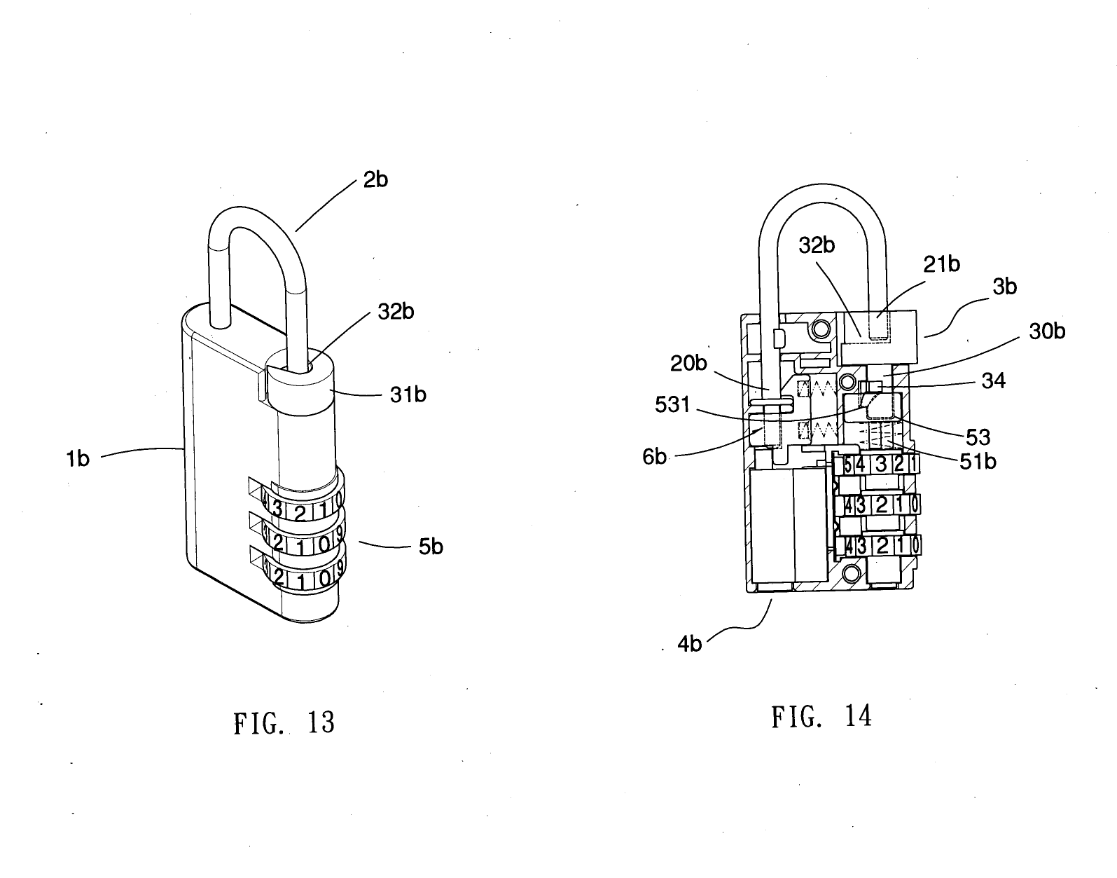

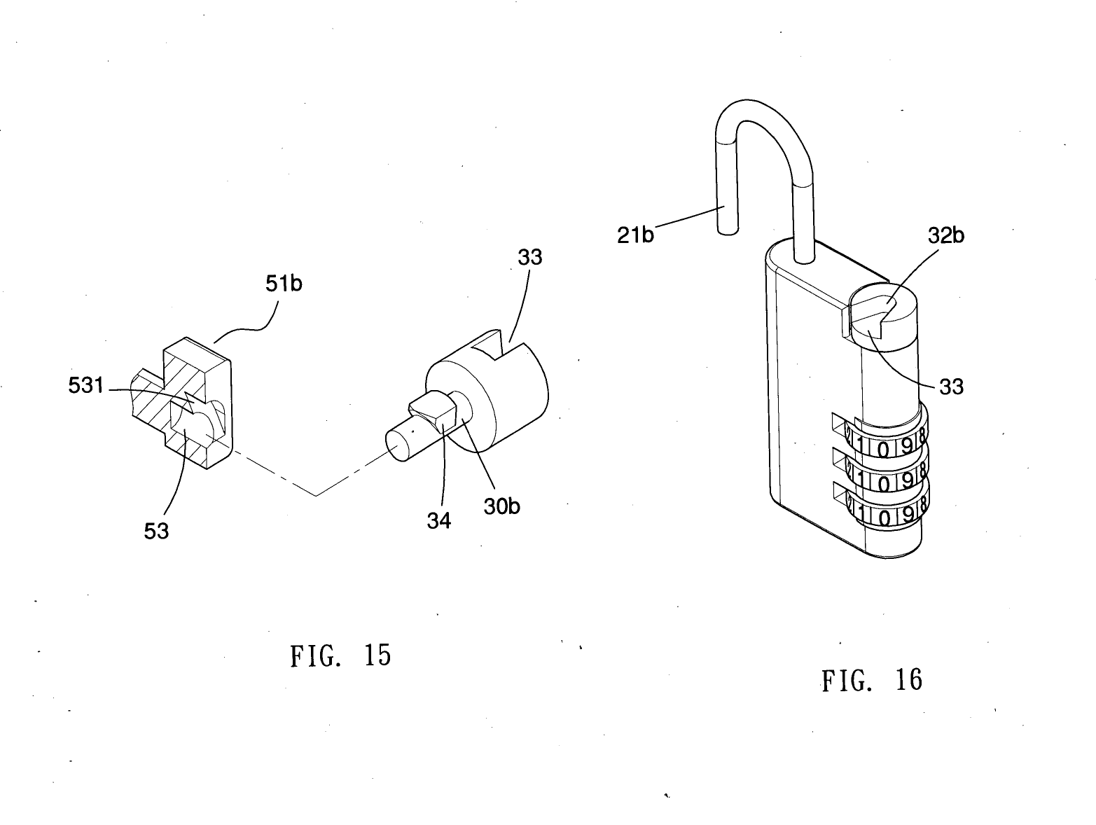

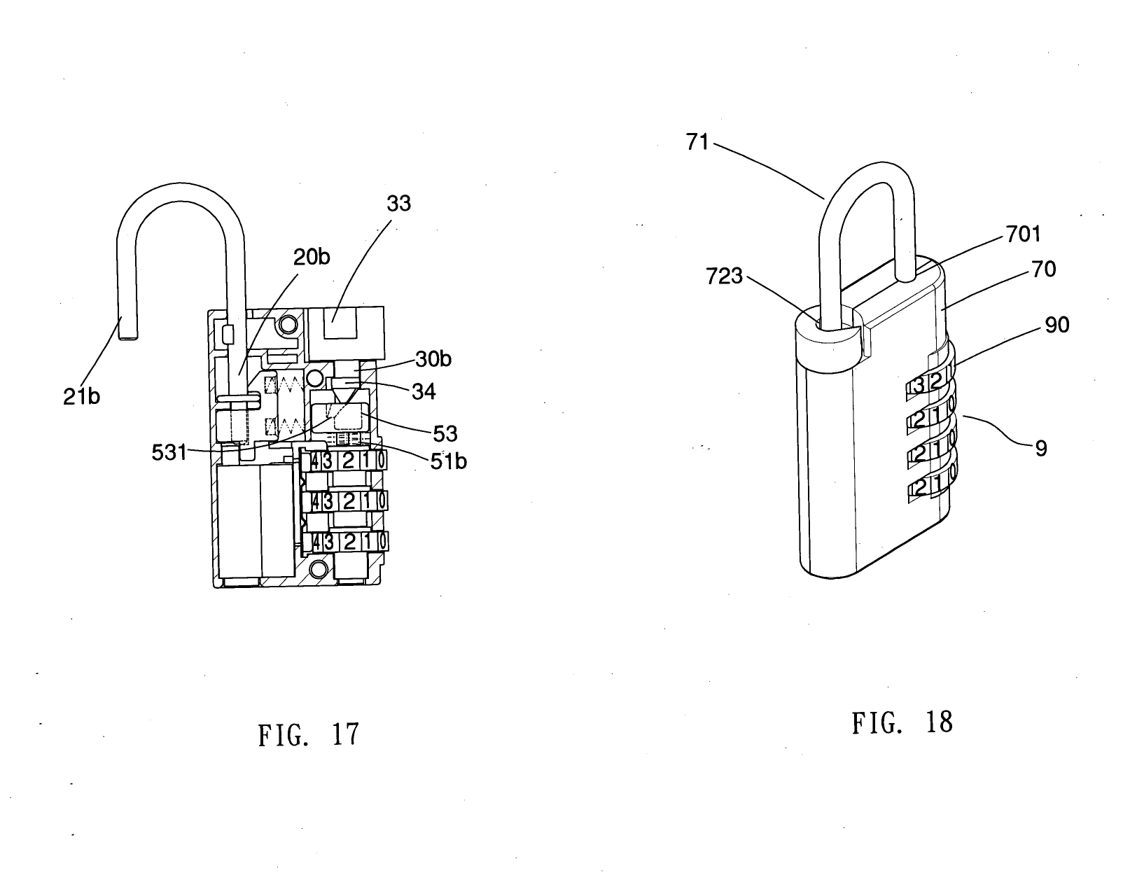

With reference to FIG. 13 to FIG. 17, the padlock of the third embodiment of the present invention contains a lock body 1b, a shackle 2b, a block 3b, a locking mechanism 6b and a key operated locking means 4b the same as the second embodiment. The stem 51b of the combination locking means 5b has a recess 53 at top thereof The recess 53 has a concave 531 at a wall thereof. The block 3b has a gap 33 communicated with the receptacle 32b of the block 3b. The gap 33 has a width larger than the diameter of the shorter arm 21b for receiving the end of the shorter arm 21b. The mounting portion 30b of the block 3b has a protrusion 34 thereon for being engaged with the concave 531. The mounting portion 30b is received in the recess 53. After dialing the combination locking means to an unlocking number, the gap 33 can be rotated to a position that the shorter arm 21b can be removed therefrom,

The first embodiment, the second embodiment and the third embodiment has the same structures having the key operated locking means 4, 4a, 4b for locking or unlocking the longer arm 20, 20a, 20b of the shackle 2, 2a, 2b and the combination locking means 5, 5a, 5b for controlling movements of the block 3, 3a, 3b in order the block 3, 3a, 3b to be engaged with or disengaged from the shorter arm 21, 21a, 21b of the shackle 2, 2a, 2b. However the opposite arrangements as follows also work.

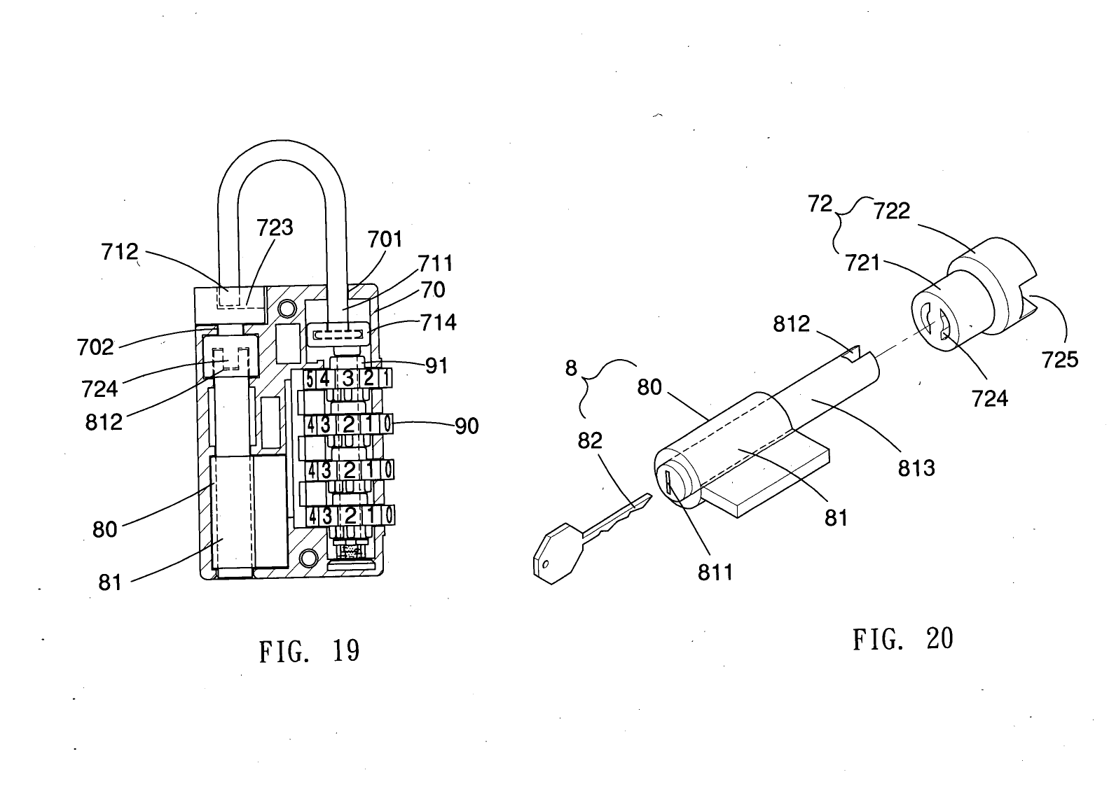

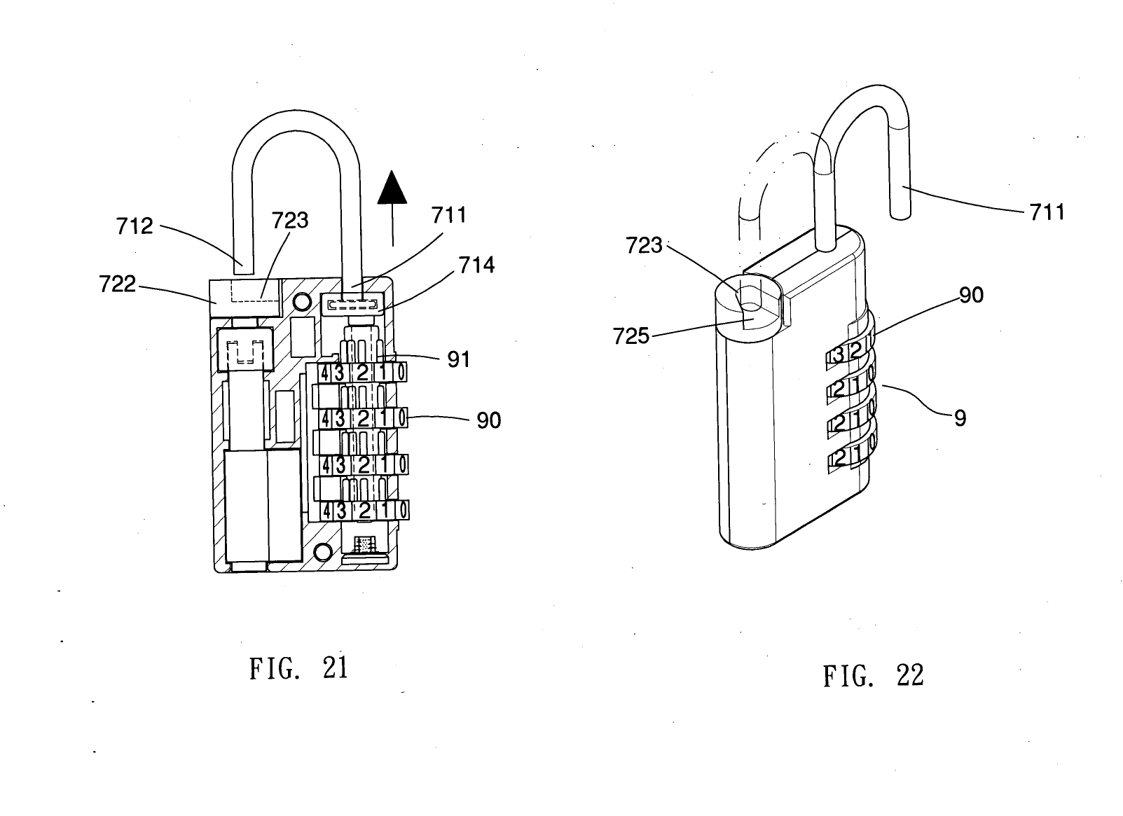

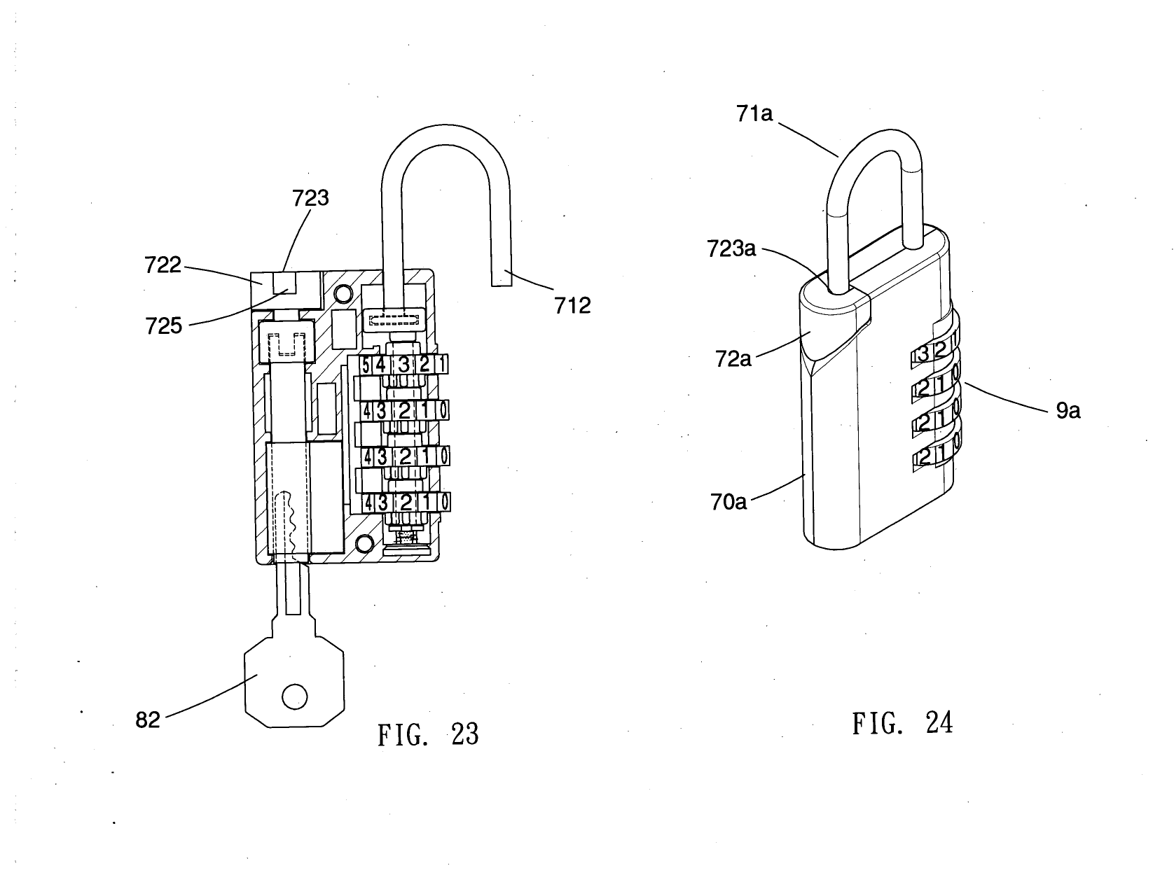

With reference to FIG. 18 to FIG. 23, the padlock of the fourth embodiment of the present invention mainly contains: a lock body 70, a block 72, a shackle 71, a combination locking means 9 and a key operated locking means 8. The lock body 70 has a first channel 701 and a second channel 702 therein. The block 72 is engaged with the second channel 702. The block 72 has a receptacle 723 therein. The shackle 71 has a longer arm 711 slidably received in the first channel 701 and a shorter arm 712 engagable with the receptacle 723 of the block 72. The combination locking means 9 formed in the lock body 70 for locking or unlocking the longer arm 711 of the shackle 71. The key operated locking means 8 is formed in the lock body 70 for controlling movements of the block 72 in order the block 72 to be engaged with or disengaged from the shorter arm 712 of the shackle 71. The block 72 has a receptacle 723 therein and a gap 725 communicated with the receptacle 723 of the block 72. The gap 725 has a width larger than the diameter of the shorter arm 712 for receiving the end of the shorter arm 712.

The block 72 contains: an engaging portion 722 having the gap 725 communicated with the receptacle 723 therein and a mounting portion 721. The key operated locking means 8 contains: a body 80 having a rotor 81 received therein and a driving rod 813 extended from the rotor 81. The rotor 81 has a keyhole 811 at a bottom end thereof for being engaged with a key 82. The gap 725 of the engaging portion 722 is engagable with the shorter arm 712 of the shackle 71 The mounting portion 721 has two sockets 724. The driving rod 813 has two plates 812 at an end thereof. The two plates 812 is engaged with the two sockets 724 for rotating the block 72. The key 82 rotates the gap 725 to a position and the shorter arm 712 can be removed from the gap 725.

The longer arm 711 of the shackle 71 has a stop 714 at an end thereof and the first channel 701 has a opening with a diameter smaller than the stop for preventing the longer arm 711 from fully sliding off the first channel 701. The combination locking means 9 contains a stem 91 lockable with the stop 714 of the longer arm 711 of the shackle 71 and plural number wheels 90 rotatably mounted around the stem 91 for locking or unlocking the longer arm 711 of the shackle 71. When the combination locking means 9 is dialed to an unlocking number, the stop 714 is released from the stem 91 and the longer arm 711 is biased upwardly thereby the shorter arm 712 is removed from the receptacle 723. The gap 725 of the receptacle 723 is a radial gap having a smallest width at an inner periphery, wherein the smallest width of the radial gap is larger than the diameter of the shorter arm 712 of the shackle 71.

With reference to FIG. 24 to FIG. 27, the padlock of the fifth embodiment of the present invention mainly contains: a lock body 70a, a block 72a, a spring 724a, a shackle 71a, a combination locking means 9a and a key operated locking means 8a. The lock body 70a has a channel 701a therein. The block 72a is pivotally received in the lock body 70a. The block 72a has a slot 723a thereon. The spring 724a is engaged with the block 72a for restoring the block 72a. The shackle 71a has a longer arm 711a slidably received in the channel 701a and a shorter arm 712a engagable with the slot 723a of the block 72a. The combination locking means 9a is formed in the lock body 70a for locking or unlocking the longer arm 711a of the shackle 71a. The key operated locking means 8a is formed in the lock body 70a for controlling rotation of the block 72a in order the block 72a to be engaged with or disengaged from the shorter arm 712a of the shackle 71a. The block 72a has a protrusion 721a thereon. The key operated locking means 8a contains a body having a rotor 81a received therein and a hemi-cylinder 812a extended from the rotor 81a. The rotor 81a has a keyhole 83a at a bottom end thereof for being engaged with a key 82a. The hemi-cylinder 812a is engaged with the protrusion 721a of the block 72a.

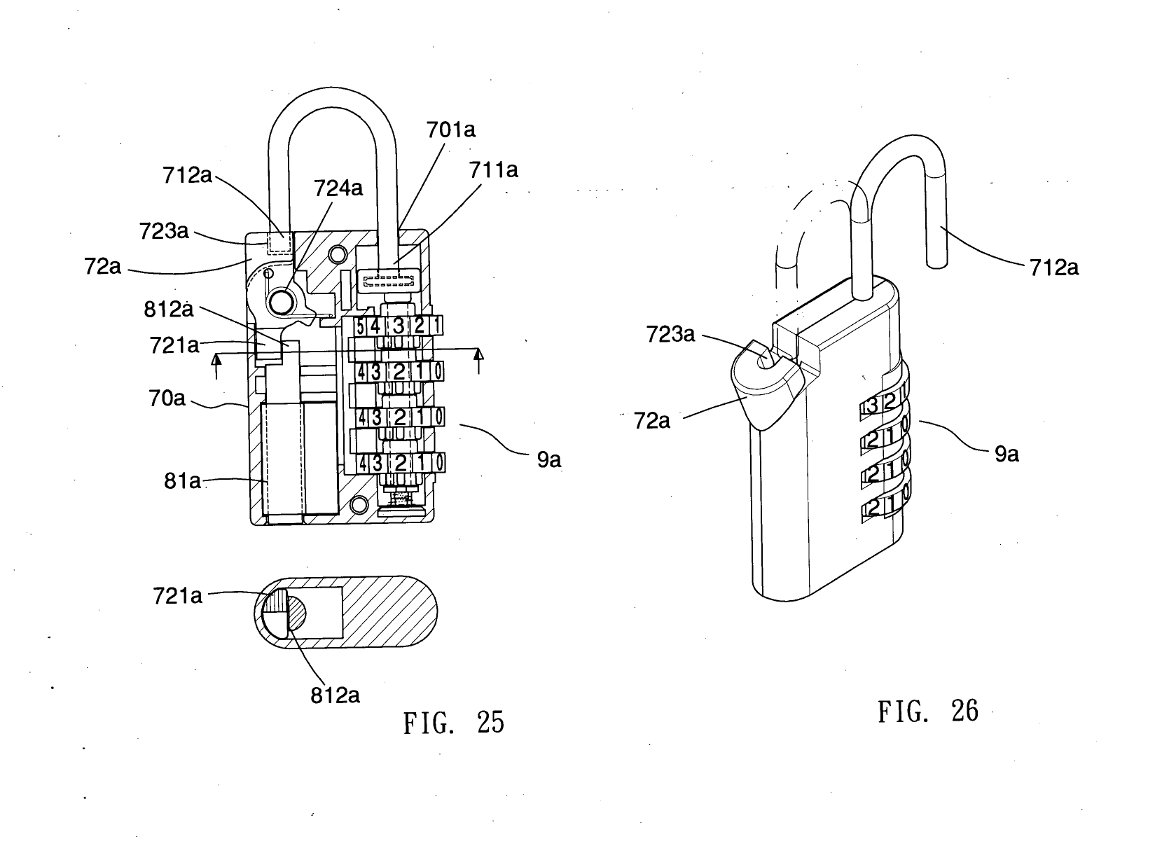

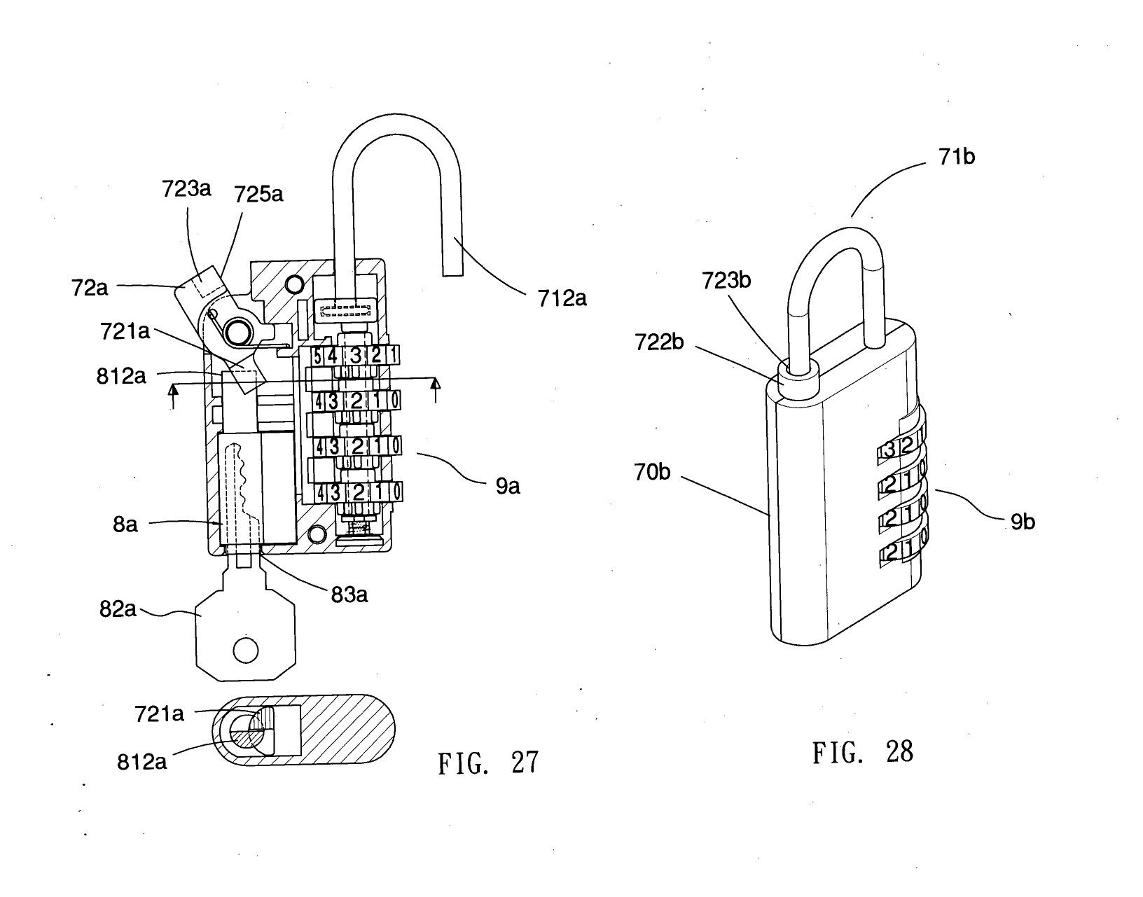

Referring to FIG. 25, the protrusion 721a is engaged with the hemi-cylinder 812a. Thereby the block 72a is prevented from rotation. Referring to FIG. 27, the key 82a rotates the rotor 81a and the hemi-cylinder 812a to a position; thereby the block 72a can rotate to let the shorter arm 712a removed from the slot 723a. The combination locking means 9a of the fifth embodiment is the same as the combination locking means 9 of the fourth embodiment.

With reference to FIG. 28 to FIG. 31, the padlock of the sixth embodiment of the present invention contains a lock body 70b, a shackle 71b, a key operated locking means 8b, and a combination locking means 9b the same as the fourth embodiment. Referring to FIG. 30, a block 72b contains an engaging portion 722b and a mounting portion 77. The engaging portion 722b has a first column 721b at one end. The first column 721b has a hole 724b therein and a first inclined surface 725b. The mounting portion 77 has a second column 771 and a cylinder 774 extended from the second column 771. The cylinder 774 is rotatable and slidably received in the hole 724b of the first column 721b. The second column 771 has a second inclined surface 773 engagable with the first inclined surface 725b of the first column 721b.

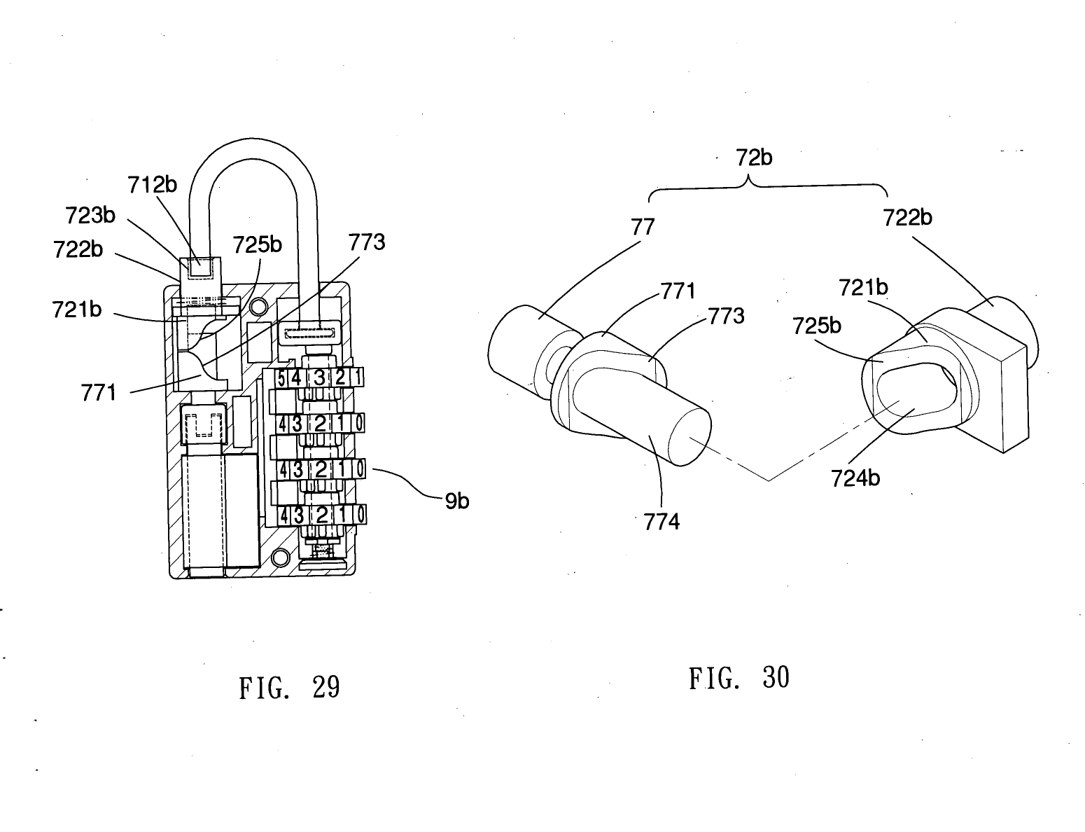

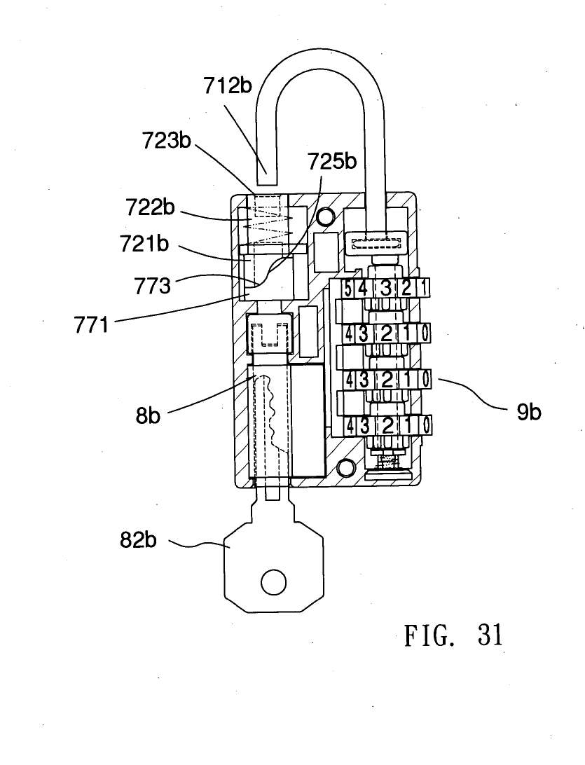

Referring to FIG. 29, when the padlock is locked, the first inclined surface 725b of the first column 721b contacts the second inclined surface 773 of the second column 771 only with their top portions. The total height of the engaging portion 722b and the mounting portion 77 is the biggest. Referring to FIG. 31 when the key 82b unlock the padlock, the first inclined surface 725b of the first column 721b fully contacts the second inclined surface 773 of the second column 771. The total height of the engaging portion 722b and the mounting portion 77 is the smallest. Thereby the engaging portion 722b of the block 72b is retreated into the lock body 70b and the shorter arm 712b is released from the receptacle 723b.

Numerous characteristics and advantages of the invention have been set forth in the foregoing description, together with details of the structure and function of the invention, and the novel features thereof are pointed out in appended claims. The disclosure, however, is illustrated only, and changes may be made in detail, especially, in matters of shape, size and arrangement of parts, materials and the combination thereof within the principle of the invention, to the full extend indicated by the broad general meaning of the terms in which the appended claims are expressed.

We claim:

1. A padlock comprising:
a lock body having a first channel and a second channel therein;
a block engaged with said second channel, said block having a receptacle therein;
a shackle having a longer arm slidably received in said first channel and a shorter arm engagable with said receptacle of said block;
a general locking means formed in said lock body for locking or unlocking said longer arm of said shackle; and
a private locking means formed in said lock body for controlling movements of said block in order said block to be engaged with or disengaged from said shorter arm of said shackle.

2. The padlock as claimed in claim 1 wherein said general locking means is a key operated locking means and said private locking means is a combination locking means, said longer arm of said shackle having a flange near an end thereof.

3. The padlock as claimed in claim 2 further comprising a first spring therein engaged with said flange of said longer arm of said shackle for biasing said shackle and a second spring located between said combination locking means and said block for biasing said block.

4. The padlock as claimed in claim 2 wherein said block comprises a engaging portion having said receptacle therein and a mounting portion under said engaging portion received in said second channel of said lock body, said combination locking means comprising a stem connected to said mounting portion and plural number wheels rotatably mounted around said stem for controlling vertical movement of said block, wherein said engaging portion is located outside of said second channel of said lock body.

5. The padlock as claimed in claim 2 wherein said block comprises a engaging portion having said receptacle therein and a mounting portion under said engaging portion rotatbly received in said second channel of said lock body, said combination locking means comprising a stem connected to said mounting portion and plural number wheels rotatably mounted around said stem for controlling rotation of said block, wherein said engaging portion is located outside of said second channel of said lock body and said receptacle has a gap with a width larger than a diameter of said shorter arm of said shackle.

6. The padlock as claimed in claim 2 wherein said key operated locking means comprises: a body having a rotor received therein and a driving rod extended from said rotor, said rotor having a keyhole at a bottom end thereof for being engaged with a key, said driving rod having a notch therein engagable with said flange of said longer arm of said shackle.

7. The padlock as claimed in claim 4 further comprising a locking mechanism formed therein comprising:
a locking block having a hook thereon engagable with said flange of said longer arm of said shackle and rectangular bump thereon; and
a spring for biasing said locking block to engage with said flange of said longer arm of said shackle.

8. The padlock as claimed in claim 5 further comprising a locking mechanism formed therein comprising:
a locking block having a hook thereon engagable with said flange of said longer arm of said shackle and rectangular bump thereon; and
a spring for biasing said locking block to engage with said flange of said longer arm of said shackle.

9. The padlock as claimed in claim 5 wherein said gap of said receptacle is a radial gap having a smallest width at an inner periphery, wherein said smallest width of said radial gap is larger than said diameter of said shorter arm of said shackle.

10. The padlock as claimed in claim 7 wherein said key operated locking means comprises: a body having a rotor received therein and a hemi-cylinder extended from said rotor, said rotor having a keyhole at a bottom end thereof for being engaged with a key, said hemi-cylinder being engaged with said rectangular bump for releasing said hook of said locking block from said flange of said longer arm of said shackle.

11. The padlock as claimed in claim 9 wherein said stem of said combination locking means having a recess at top thereof, said recess having a concave at a wall thereof, said mounting portion of said block having a protrusion thereon for being engaged with said concave, wherein said mounting portion is received in said recess.

12. A padlock comprising:
a lock body having a first channel and a second channel therein;
a block engaged with said second channel, said block having a receptacle therein;
a shackle having a longer arm slidably received in said first channel and a shorter arm engagable with said receptacle of said block;
a combination locking means formed in said lock body for locking or unlocking said longer arm of said shackle; and
a key operated locking means formed in said lock body for controlling movements of said block in order said block to be engaged with or disengaged from said shorter arm of said shackle.

13. The padlock as claimed in claim 12 wherein said block comprises: an engaging portion having said receptacle therein and a mounting portion under said engaging portion, said key operated locking means comprising a body having a rotor received therein and a driving rod extended from said rotor, said rotor having a keyhole at a bottom end thereof for being engaged with a key, said driving rod being engaged with said mounting portion of said block, said receptacle has a gap with a width larger than a diameter of said shorter arm of said shackle to be engaged therewith.

14. The padlock as claimed in claim 12 wherein, said longer arm of said shackle having a stop at an end thereof and said first channel having a opening with a diameter smaller than said stop for preventing said longer arm from fully sliding off said first channel, said combination locking means comprising a stem lockable with said stop of said longer arm of said shackle and plural number wheels rotatably mounted around said stem for locking or unlocking said longer arm of said shackle.

15. The padlock as claimed in claim 13 wherein said mounting portion has two sockets, said driving rod having two plates at an end thereof, said two plates being engaged with said two sockets for rotating said block.

16. The padlock as claimed in claim 14 wherein said block comprises: an engaging portion having said receptacle therein and a mounting portion engagable with said engaging portion, said key operated locking means comprising a body having a rotor received therein and a driving rod extended from said rotor, said rotor having a keyhole at a bottom end thereof for being engaged with a key, said driving rod being engaged with said mounting portion of said block.

17. The padlock as claimed in claim 16 wherein said engaging portion having a first column at one end, said first column having a hole therein and an first inclined surface, said mounting portion having a second column and a cylinder extended from said second column, rotatable received in said hole of said first column, said second column has a second inclined surface engagable with said first inclined surface of said first column.

18. The padlock as claimed in claim 17 wherein said mounting portion has two sockets at an end, said driving rod having two plates at an end thereof, said two plates being engaged with said two sockets for rotating said mounting portion of said block to retreat said engaging portion to release said shorter arm of said shackle from said receptacle of said block.

19. A padlock comprising:
a lock body having a channel therein;
a block pivotally received in said lock body, said block having a slot thereon;
a spring engaged with said block for restoring said block;
a shackle having a longer arm slidably received in said channel and a shorter arm engagable with said slot of said block;
a combination locking means formed in said lock body for locking or unlocking said longer arm of said shackle; and
a key operated locking means formed in said lock body for controlling rotation of said block in order said block to be engaged with or disengaged from said shorter arm of said shackle.

20. The padlock as claimed in claim 19 wherein said block has a protrusion thereon, said key operated locking means comprising a body having a rotor received therein and a hemi-cylinder extended from said rotor, said rotor having a keyhole at a bottom end thereof for being engaged with a key, said hemi-cylinder being engaged with said protrusion of said block.
